(19) United States
(12) Patent Application Publication
(10) Pub. No.: US 2004/0209042 A1
(43) Pub. Date: Oct. 21, 2004

(54) Breathable elasctic web

(76) Inventor: Andrew J. Peacock, Terre Haute, IN (US)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(21) Appl. No.: 10/717,960

(22) Filed: Nov. 21, 2003

Related U.S. Application Data
(60) Provisional application No. 60/463,079, filed on Apr. 15, 2003.

(51) Int. Cl. B32B 3/10

(52) U.S. Cl. 428/136

(57) ABSTRACT

An embodiment of the present invention relates to an elastic web that can be made breathable upon application of a tensile force such as would be encountered in certain applications, such as in diapers and other hygiene articles, and bandages. Breathability is achieved by insertion into the web of slits whose open area increases upon application of a force on the web acting along the major axis of said slits.

### CROSS REFERENCE TO RELATED APPLICATION

This application claims priority from provisional application 60/463,079 filed Apr. 15, 2003, the disclosure of which is incorporated by reference herein in its entirety.

### BACKGROUND OF THE INVENTION

1. Field of the Invention

Various embodiments of the present invention relate to an elastic web that can be made breathable upon application of a tensile force, such as might be encountered in certain applications. Specifically, the elastic web may be made breathable when used in, for example, diapers and other personal hygiene articles, and bandages, which typically result in application of a tensile force on the web.

2. Description of Related Art

Absorbent articles such as diapers, training pants or incontinence garments are required to provide a close, comfortable fit about the wearer and contain body exudates while maintaining skin health. Many conventional absorbent articles typically have employed fasteners that attach the waist sections of the articles around a wearer as well as various configurations of waist elastics, leg elastics, elasticized liners, and elasticized outer covers. The fasteners and elastic components have been employed to help produce and maintain the fit of the articles about the body contours of the wearer that can lead to improved containment and comfort.

Skin health is believed to be promoted by keeping the humidity of the air that is in contact with the skin low. In an attempt to reduce the humidity level within such absorbent articles, breathable polymer films have been employed as outer covers. The breathable films typically are constructed with pores to provide desired levels of liquid impermeability and air permeability. Other absorbent article designs have been arranged to provide breathable regions in the form of breathable panels or perforated regions in otherwise vapor-impermeable outer covers to help ventilate the articles.

Elastic materials that are intended for use in diapers and other disposable articles can be made breathable by making them with holes or three dimensional cones that permit air to pass through. For example, U.S. Pat. Nos. 6,303,208 and 5,733,628 to Pelkie (the '208 and '628 patents, respectively), the disclosures of which are incorporated herein by reference in their entirety, disclose permeable vacuum formed three dimensional elastic webs. The films disclosed in these patents are relatively thick, and the holes formed through the films may impact the structural integrity of the film.

U.S. Pat. No. 6,452,063, to Curro et al. (hereinafter referred to as the '063 patent), the disclosure of which is incorporated herein by reference in its entirety, discloses a 3-dimensional apertured elastic web having elongate apertures. The web is stretchable in a direction perpendicular to the major axis of the elongate aperture.

While the '063 patent discloses porous, elastomeric webs with good stretching characteristics, the 3-dimensional webs have poor recovery.

The use of slits to provide apertures in a polymeric web following stretching of the web is disclosed in U.S. Pat. No. 3,985,599 to Lepoutre and Pieniak (hereinafter referred to as the '599 patent), the disclosures of which are incorporated by reference herein in their entirety. However, the '599 patent specifically provides for a means for permanently imparting stretch to a web in a way that produces permanently stretched ligaments that have increased tensile properties over the unstretched web. The '599 patent discloses that the presence of apertures as a result of this stretching is undesirable.

The description herein of certain disadvantages associated with known methods and materials is not intended to limit the scope of the embodiments of the present invention. Indeed, embodiments of the invention may incorporate one or more known methods, materials, and/or apparatus, without suffering from these disadvantages.

### BRIEF SUMMARY OF THE INVENTION

Despite the attempts to develop materials for improved absorbent articles, there remains a need for materials that can provide elasticity and breathability, without sacrificing the physical properties that are necessary for the application in disposable articles or their manufacture.

Various embodiments of the present invention overcome the above-mentioned limitations of existing elastic breathable webs by providing an elastic web that exhibits porosity when subjected to a tensile force that is acting substantially in the direction that the material generally would be subjected to in the application for which it is intended. The inventor has discovered that it is possible to manufacture webs that contain regions that contain slits, and that the presence of such slits has little or no effect on the tensile properties of the web when the tensile force is acting substantially in the direction that the material would be subjected to in the application for which it is intended. Furthermore, these slits provide a mechanism for imparting porosity and hence breathability to the web when a tensile force is applied thereto. The product of an embodiment of the present invention is a slit film that is unapertured in its relaxed state, but is rendered breathable in a reversible manner. Apertures are a desirable feature of the stretched web in order that breathability be achieved.

According to one embodiment of the present invention, the web comprises an elastic web into which is inserted by a slitting mechanism, a plurality of slits, a majority of them having their major axes oriented in such a direction that they are within 45° of a common direction. In a preferred embodiment of the present invention, the slits have an aspect ratio (i.e., ratio of major axis to minor axis) greater than about 5, more preferably, greater than about 25, and all of their major axes are pointed in essentially the same direction. When a tensile force is applied to the web in the direction in which the major axes are pointed, the ligaments between the slits stretch and also neck, causing the slits to widen into apertures. The apertures then provide breathability to the web. The level of breathability increases with an increase in the elongation of the web.

The elastic web of an embodiment of the present invention can be combined with one or more webs to provide a soft texture that may be more useful or appealing in some applications. Such webs can be fibrous in nature, examples being nonwoven and woven materials. This embodiment of the invention includes a composite material that comprises the elastic web described previously and an additional web. The composite material may be prepared by laminating the webs together, coextrusion, or any other suitable method for making the composite material.

### BRIEF DESCRIPTION OF THE DRAWINGS

FIG. 1 depicts regions of slits in a continuous web surface.

FIG. 2 illustrates a continuous region of slits within which are discontinuous regions of web.

FIG. 3 illustrates examples of regions of slits that are continuous stripes.

FIG. 4 illustrates an example of a row of slits laid out in one row in one direction in the plane of the web.

FIG. 5 depicts an example of a common direction, in which regions of slits are laid out in parallel, non parallel, linear and non linear rows, but share a common direction in the plane of the web.

FIG. 6 illustrates a set of slits that are used to define the terms “slit length”, “absolute slit separation”, and relative slit separation.

FIG. 7 depicts slits that define the terms “absolute row separation” and “absolute row offset” for slits that are positioned in rows.

FIG. 8 illustrates a region of slits that are defined by the expression (1.5 in/1.0/0.33/0.5).

FIG. 9 reveals an example of a set of slits that are oriented such that their major axes are within a pre determined angle of a common direction.

FIG. 10 depicts a region of slits that has been subjected to a tensile force and shows regions that have been opened as a result of the applied force. The area of the regions can then be used to define an open area for the web.

### DETAILED DESCRIPTION OF THE INVENTION

Previously known elastic webs that have pre-formed holes in them suffer from a disadvantage in that the presence of holes in such structures reduces the physical strength of the web, as measured for example by tensile properties such as strength and elongation at break. Consequently, the known apertured materials necessitate a thicker, and therefore more expensive, construction than would otherwise be sufficient for a non permeable elastic web. Such webs with pre-formed holes also suffer from the disadvantage that when they are subjected to tensile forces, the holes tend to close, thereby reducing their porosity and hence their breathability.

Embodiments of the present invention relate to breathable elastomeric webs that can be used alone, or as a composite, or preferably, a laminate construction with one or more support webs. It is to be understood that the terms “elastic” and “elastomeric” can be used interchangeably throughout this description.

The elastomeric web of an embodiment of the present invention has an advantage over known breathable elastomeric products because breathability is imparted to the inventive web when a tensile force that is sufficient to elongate the web by more than about 10% is applied to the web. It also is to be understood that the terms “breathability” and “porosity” may be used interchangeably throughout this description. The breathability of the web increases with the elongation of the web, and the amount of elongation that is required to impart a desired level of breathability that is useful in certain applications is typical of the elongation that the web would be subjected to in those applications.

The webs of embodiments of the invention are useful in such applications as disposable diaper waistbands, fastening components and side panels, wherein the web is subjected to a hoop stress as the diaper conforms to the waist of the wearer (e.g., baby or adult). The inventive webs also may be used in a bandage, wherein a stress is imparted to the bandage in order to keep it attached to the body part that is being bandaged. These examples are not to be taken as exclusive applications for the webs of this invention, which would find application in any area where breathability under the influence of stress would be desirable.

Embodiments of the present invention provide elastic materials that contain apertures and are breathable when stretched, and in particular, breathable when stretched by a tensile force acting in the direction of the force that the material would experience in end use conditions (e.g., in a diaper side tab that would normally experience the hoop stress of the diaper waist band when gripping the wearer's waist). Another example of stress in the direction of the force that the material would experience in end use conditions includes the stress that would be experienced by a bandage that is wrapped in around a body part, or that is stretched and then adhered.

Embodiments of the invention also provide elastic materials that are breathable when stretched, but that retain essentially all of the physical properties of an unapertured web. Such materials do not suffer the disadvantage of the significant loss of physical properties normally associated with a web that is apertured, and hence made breathable by such processes as hot needle punching or vacuum forming.

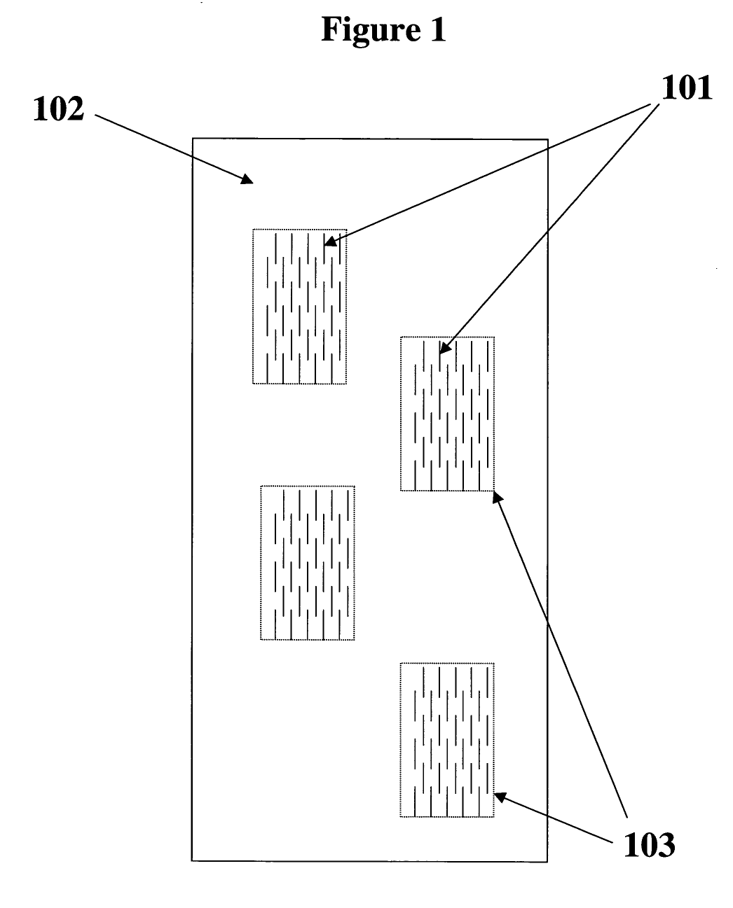

The embodiments of the present invention can be understood by reference to the following definitions, and the FIGS. 1 to 10, as referenced below.

The term “web” refers to a material capable of being wound into a roll. Webs can be film webs, nonwoven webs, laminate webs, apertured laminate webs etc.

The term “essentially” when used to describe a property of the invention is taken to mean that the property can deviate by ±(plus or minus) 10% of its stated value. In the case of an angle between two directions, the term “essentially” means within ±10° of the stated angle.

Throughout this description, the expressions “unapertured film” or “unapertured web” refers to films or webs that have not had holes, apertures, pores or slits inserted in it for the purpose of making it breathable to air or water vapor, without application of a tensile force. The term “breathable” in the context of the present disclosure means having a porosity of at least about 1.0 (m³/m²/min) when tested under the conditions specified in the section entitled “Test Methods.”

As used herein, the term “elastic” is used to describe a material that upon application of a tensile force is extensible to a stretched length, preferably at least 100% of its initial, unstretched length, and that exhibits a recovery of more than 25% according to:

Recovery (%)=100×(Ls−Lf)/(Ls−Lo)

Where:

Lo=initial length

Ls=stretched length

Lf=final length

As used herein, a “slit” is defined as an elongated hole having major and a minor axes. The ratio of the length of the major to the minor axis is the aspect ratio of the slit, which in various embodiments of this invention is preferably greater than 5.0, and more preferably greater than 10.0 and even more preferably greater than 20.0, and most preferably greater than 100.0.

As used herein, a slit may have linear or non-linear sides, which may or may not be parallel with each other. Examples of non-linear sides include curved or wavy lines. Alternatively, the slit may have sides comprising two or more linear or curved segments that meet at acute or obtuse angles.

As used herein, the term “number density” refers to the number of slits per square inch in the regions of the web surface.

According to one embodiment of the invention, the web comprises a top surface and a bottom surface with one or more regions having a plurality of slits. The web comprises a stretchable web into which is inserted by a slitting mechanism, a plurality of slits, the majority of them having their major axes oriented in such a direction that they are within 45° of a common direction on the web surface. In another preferred embodiment of the web, the slits are aligned each with their major axes oriented at an angle either within 30° of a common direction on the web surface. Yet, in another preferred embodiment, the slits are aligned each with their major axes oriented at an angle either within 15° of a common direction on the web surface. In a preferred embodiment of the web, the slits are aligned each with their major axes essentially parallel to a common direction on the web surface. In a preferred embodiment of the web, the lengths of the major axes of the slits are in the ranges of about 0.25 to about 25 mm. In other preferred embodiments, the lengths of the major axes of the said slits are between about 1.25 and and about 12.5 mm and between about 2.5 and about 6.25 mm.

According to one preferred embodiment of the web, the slits have an aspect ratio (e.g., ratio of major axis to minor axis) greater than about 25, and all of their major axes are pointed in essentially the same direction. In a preferred embodiment, the slits are characterized by a major and minor axes, the ratio of the major axis to minor axis (aspect ratio) being more than about 5. When a tensile force is applied to the web in the direction where the major axes are pointed, the ligaments between the slits stretch and also neck, causing the slits to widen into apertures. The slits also open when a tensile force is applied to the web along the common direction. The apertures then provide breathability to the web. The level of breathability increases with an increase in the elongation of the web.

In a more preferred embodiments of the web, the slits are organized into regions on the web surface. These regions have a boundary, outside of which slits cannot be found on the web surface except inside another region. Within the said regions, the slits are arranged in a regular array, which can be characterized by four parameters, that describe the size of a slit, and its position relative to other slits in the array. In an embodiment of the web, the arrangement of slits within any one or more of said regions is organized in an array, said array comprising rows of slits that are essentially parallel in their long axes, said rows being characterized by the slit length, SL, the relative slit separation, SS, the relative row separation, RS, and the relative row offset, RO. The most preferred embodiments have a density and size of slits that is appropriate for the application for which the web is intended. For example, for a diaper waistband application, the slit length (SL) may be in the range of 0.25 to 25 millimeters (mm), and more preferably 1.25 to 12.5 mm, and most preferably 2.5 to 6.25 mm. In a preferred embodiment of the web, the array has a hexagonal symmetry such that the row offset value RO=SS/2. In another preferred embodiment, the array has a rectangular symmetry such that the row offset value RO=0 (zero). In yet another preferred embodiment, the array has a staggered configuration such that the row offset value RO is not equal to SS/2. In another preferred embodiment of the web, the value of RS, the relative row separation of the array, is between −0.9 and 10.0. In other preferred embodiments, the relative row separation of the array, is between −0.25 and 2.0. In a preferred embodiment, the relative row offset value of RO is less than 0.5. In another preferred embodiment the relative row offset value of RO is less than 0.25.

In another embodiment of the web, the slits are positioned randomly within any one or more of said regions in the web. The major axes of the slits are oriented randomly in the plane of the web. The effectiveness of this embodiment of the invention is not entirely dependent on the regularity of the arrangement of the slits in a region, and a random array will suffice to provide the benefits described herein.

According to another preferred embodiment of the web, the number density of slits per square inch within any one or more of said regions is between 5 and 1,000. In another preferred embodiment of the web, the number density of slits per square inch within any one or more of said regions is between 10 and 500. In other preferred embodiments of the web, the number density of slits per square inch within any one or more of said regions is between 20 and 100.

In another preferred embodiment of the web, the total length of slits per square inch within any one or more of said regions is between 0.5 and 50 inches/square inch. In another preferred embodiment, the total length of slits per square inch within any one or more of said regions is between 1 and 25 inches/square inch. Yet, in another preferred embodiment, the total length of slits per square inch within any one or more of said regions is between 2.0 and 10 inches/square inch.

Elastomeric materials that are useful as a material of construction of the elastic web in embodiments of the present invention include polyolefin type materials such as polyethylene elastomers, and polyurethane webs. In preferred embodiments, the preferred elastomeric web material is capable of achieving essentially full recovery after being stretched at least about 300 to about 400% of its original length. Suitable stretchable elastomeric webs comprise natural polymeric materials and synthetic polymeric materials including isoprenes, butadiene-styrene materials and other elastomers. Other suitable elastomers comprise styrene block copolymers such as styrene/isoprene/styrene (SIS), styrene/butadiene/styrene (SBS), or styrene/ethylene-butene/styrene (SEBS) block copolymers. Blends of these polymers alone or with other modifying elastic or non-elastomeric materials are also contemplated for being useful with the embodiments of the present invention. In certain preferred embodiments, the elastomeric materials can comprise such high performance elastomeric material such as Kraton™ elastomeric resins from Kraton Polymers that are elastomeric block copolymers.

The elastic web of an embodiment of the present invention can be combined with one or more webs to provide a soft texture that may be more useful or appealing in some applications. Such webs can be fibrous in nature, and preferably are nonwoven and woven materials. This embodiment of the invention includes a composite material that comprises the elastic web having slits, as described previously, and an additional web. The composite material may be prepared by laminating the webs together, coextrusion, or by any other suitable method for making the composite material.

Examples of methods of making laminates of elastomeric materials and other webs are disclosed in U.S. Pat. Nos. 6,475,600, 5,156,793, and 5,422,172, the disclosures of each of which are incorporated herein by reference in their entirety. The '600 patent discloses a breathable composite material formed from at least one layer of an elastic material and a necked laminate of sheet layers. The breathable laminate is made by first partially stretching a filled non-elastic film layer, attaching a non-elastic neckable layer to form a laminate and then stretching the laminate to neck the laminate and lengthen the film to its desired fully stretched configuration. The '793 patent discloses a “zero strain” stretch laminate web exhibiting a non-uniform degree of elasticity, as measured in the direction of elasticization at various points along an axis oriented substantially perpendicular to the direction of elasticization. The “zero strain” stretch laminate material is formed of at least two piles of material that are ether intermittently or substantially continuously secured to one another along at least a portion of their coextensive surfaces while in a substantially untensioned condition. The '172 patent discloses an elastic laminated sheet of an incrementally stretched nonwoven fibrous web and an elastomeric film that have properties of stretchability and recoverability. The laminate is made by the method of extrusion or adhesion of the nonwoven fibrous web to the elastomeric film. Those skilled in the art are capable of making a composite material from the slitted elastic web and another web, using the guidelines provided herein.

Turning now to the figures, a slit region, or region of slits, of the web's surface is taken to be an area where a multiplicity of slits can be found. The slit region can be discrete, and provide the appearance of an island or islands in an otherwise continuous web surface. An example of such an arrangement of slits is shown in FIG. 1, which is to be understood as an example, and not to limit the possible arrangements of slits or regions that represent various embodiments of the present invention. In FIG. 1, a web (102) comprises regions (103) each of which comprise a plurality of slits (101). The regions (103) are depicted as bounded by dotted lines, for the sake of demonstrating the boundaries of said regions. The dotted lines are not to be construed as constructs on the web. In the example of FIG. 1, the unapertured regions of the web (102) form a continuous surface where the regions may appear as “islands.”

The slits in the regions shown in FIG. 1 can be seen to be arranged in a regular array, where rows of slits form a hexagonal array. It should be understood that the effectiveness of this embodiment of the invention is not dependent on the regularity of the arrangement of the slits in a region, and a random array will suffice to provide the benefits described herein.

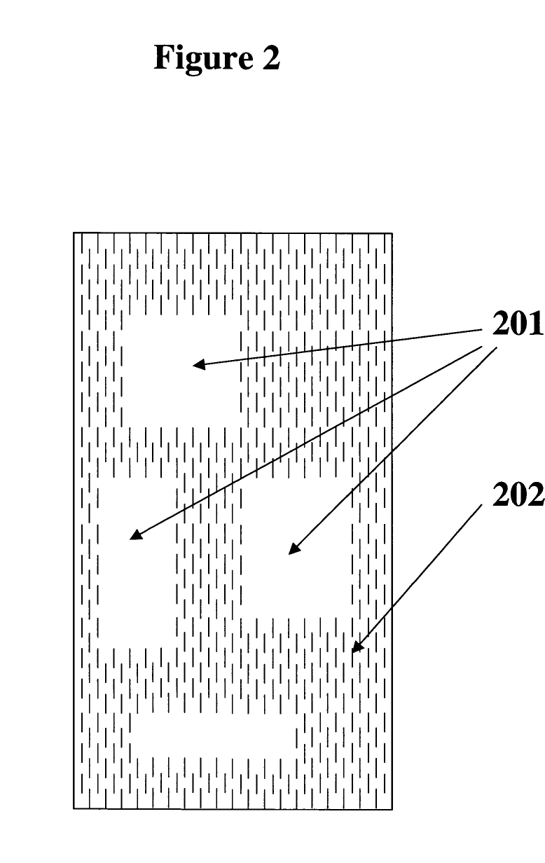

FIG. 2 illustrates an example of how the slit region can be continuous in a given sample, with unslit regions (201) that provide the appearance of islands in a continuous region of slits (202). Again, FIG. 2 is to be understood as an example and not to limit the possible arrangements of slits or regions that represent embodiments of the present invention.

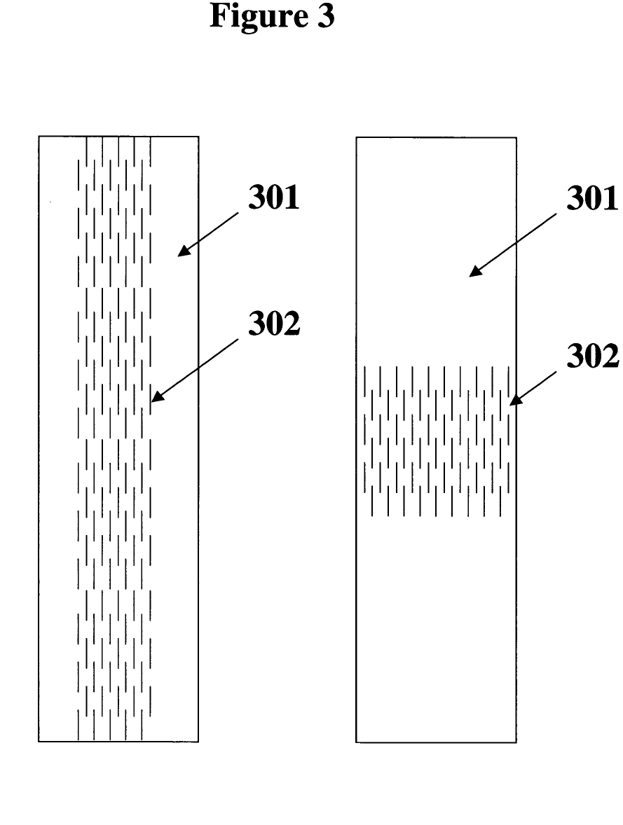

Alternatively, the slit region can be viewed as one or more continuous stripes along the length or across the width of a web, as presented schematically in FIG. 3. In FIG. 3, continuous striped slit regions (302) are shown in an otherwise unslit web (301).

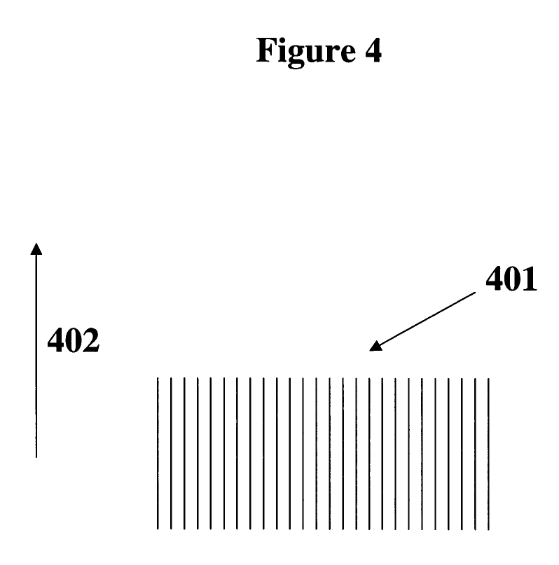

A “Row of slits” is defined as in FIG. 4, where a region is laid out in a row in one direction of the web. The slits (401) in FIG. 4 are laid out with their major axes in a common direction (402).

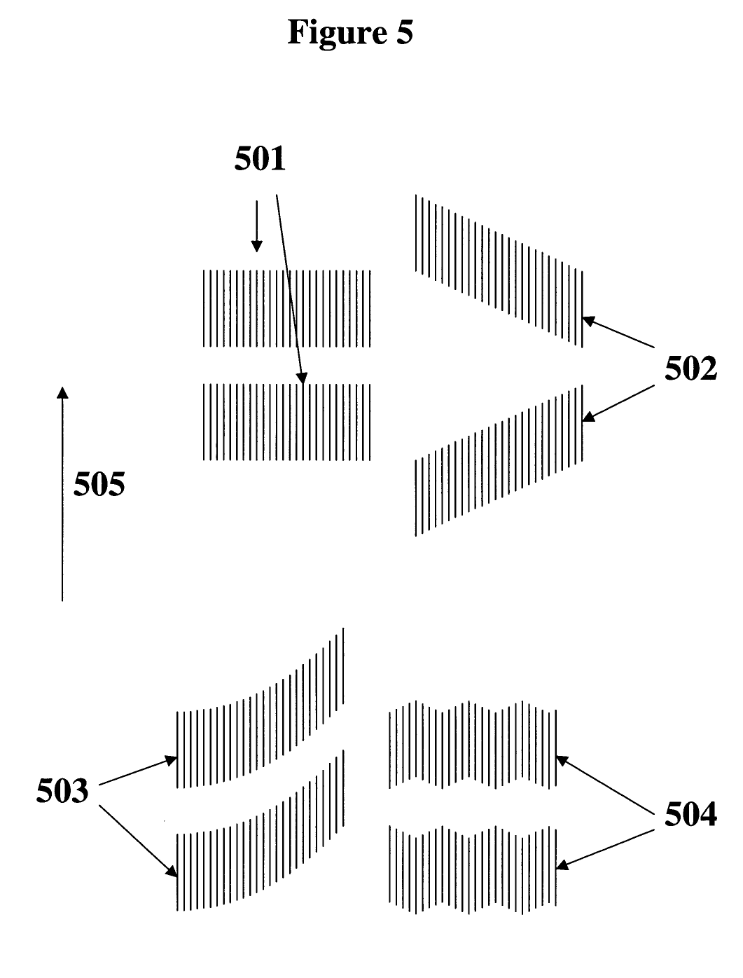

A “Striped Pattern” is depicted in FIG. 5, where regions of slits are laid out in parallel (501 and 503), or non-parallel (502 and 504), linear (501 or 502) or non-linear (503 or 504) rows sharing a common direction (505) in the plane of the web. In each of the four examples of patterns shown in FIG. 5, the major axes of the slits share a common direction (505).

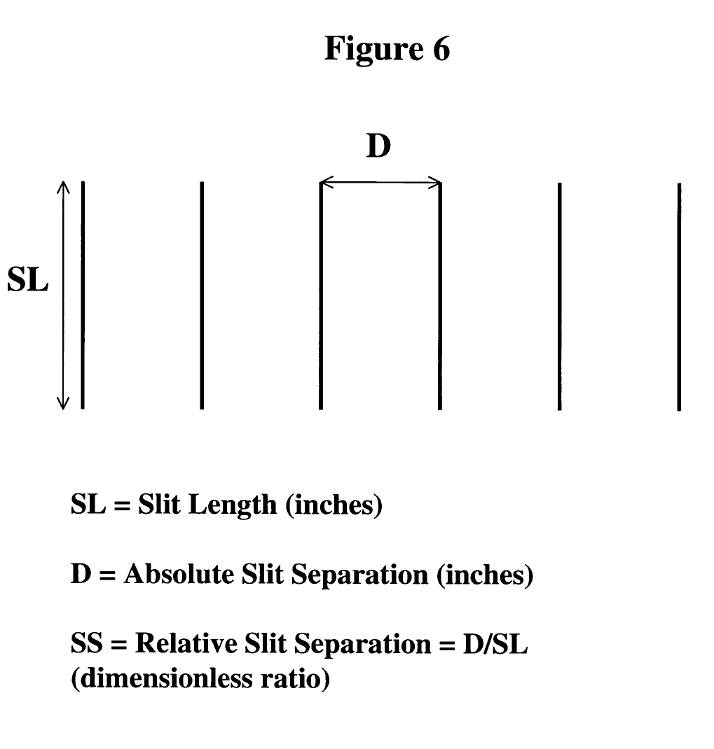

The expressions “Slit Length” (SL) and “Relative Slit Separation” (SS) refer to dimensional parameters of the slit regions of the web of the invention, and can be understood more fully by reference to FIG. 6. These definitions are understood to be applicable to any row of slits where SL is the length of the slit in inches, D is the absolute slit separation in inches, and SS is equal to D/SL.

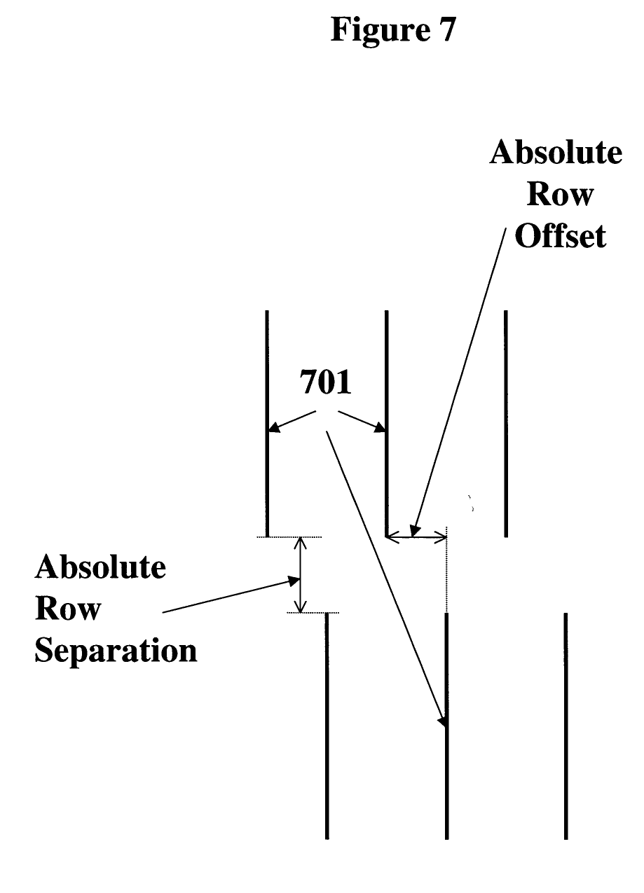

The expressions “Absolute Row Separation” and “Absolute Row Offset” refer to dimensional parameters of the slit regions of the web of the invention where slits can be identified as being positioned in adjacent rows. These expressions can be better understood by reference to FIG. 7, where they are defined for the set of slits (701) illustrated therein.

The expressions “Absolute Row Separation” and “Absolute Row Offset” can be used to define parameters that can be further applied to any set of slits arranged in adjacent rows. For the purpose of characterizing such a set of slits, the expression relative row separation (RS) is defined as the measured Absolute Row Separation divided by SL (slit length). The expression “relative row offset” (RO) is equal to the “Absolute Row Offset” between rows divided by the measured separation between slits (SL).

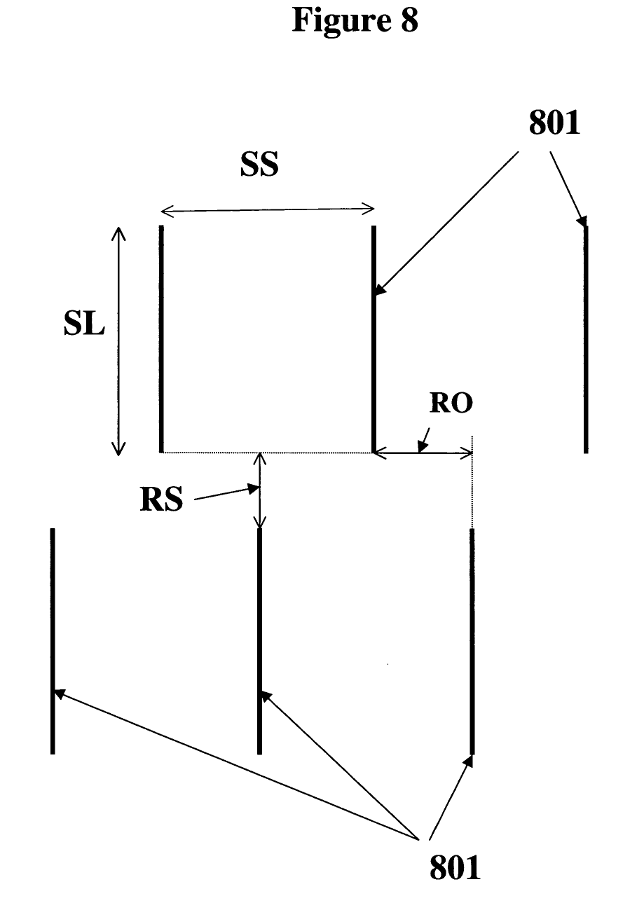

A region of slits in a web can therefore be characterized by four numbers, SL/SS/RS/RO, the latter three numbers of which are dimensionless. This terminology will be used when describing examples of this invention. For example, the terminology 1.5 in./1.0/0.33/0.5 refers to the slit pattern that is depicted in FIG. 8:

SL=1.5 in;

SS=1.0 (=1.5 in/1.5 in);

RS=0.33 (=0.5 in/1.5 in);

and

RO=0.5 (=0.75 in/1.5 in).

It is to be understood that FIG. 8 may not be drawn to scale, but rather is a schematic representation of a slit region in which the Slit Separation, the Absolute Row Separation and the Absolute Row Offset are in the ratios specified to the slit length in the example.

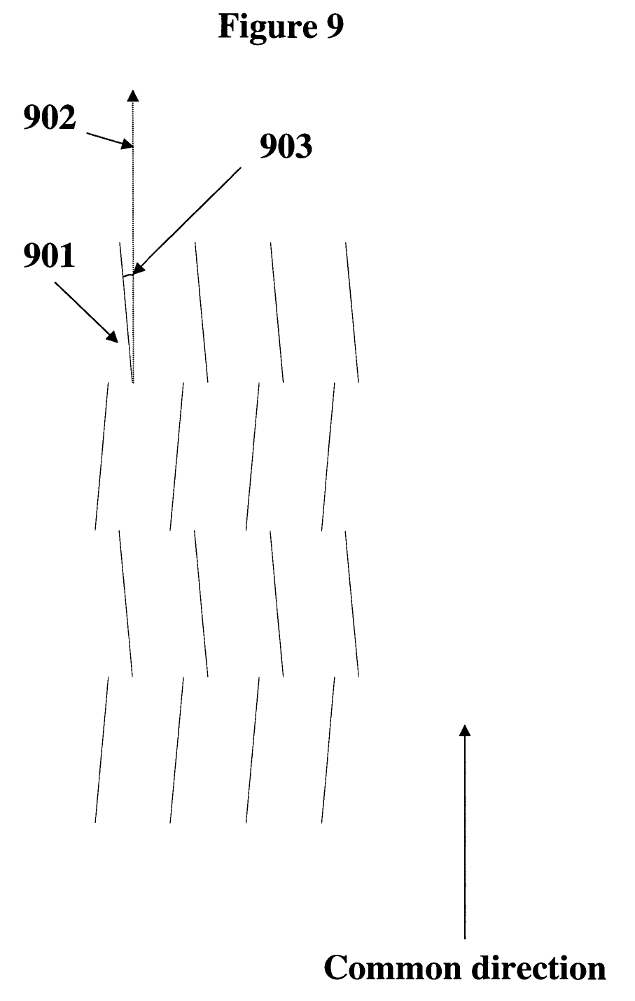

The expression “common direction” as it is used throughout this description denotes any direction in the plane of the web, with respect to which an angle with the major axis of each individual slit can be measured. For example, if the orientation of the major axes of all slits are no more than +/−5° from a common direction, the common direction can be found in the plane of the web that is pointed no more than 5° from the directions of the major axes of all of the slits in the region. FIG. 9 illustrates an example of a common direction (904) of the region of slits. A slit (901) has an angle (903) to a direction (902). The direction (902) also makes an angle to all of the other major axes of the slits in the region and can be defined by the maximum angle of the set of all angles it makes with all of the slits. The common direction is the direction in which the angle (903) of the major axes of the slits varies by only 5°.

The term “randomly” when used to describe the positioning of slits in the plane of the web refers to the fact that no discernable regular pattern, for example rectangular, hexagonal, etc., can be seen in the way that slits are arranged in the surface of the web.

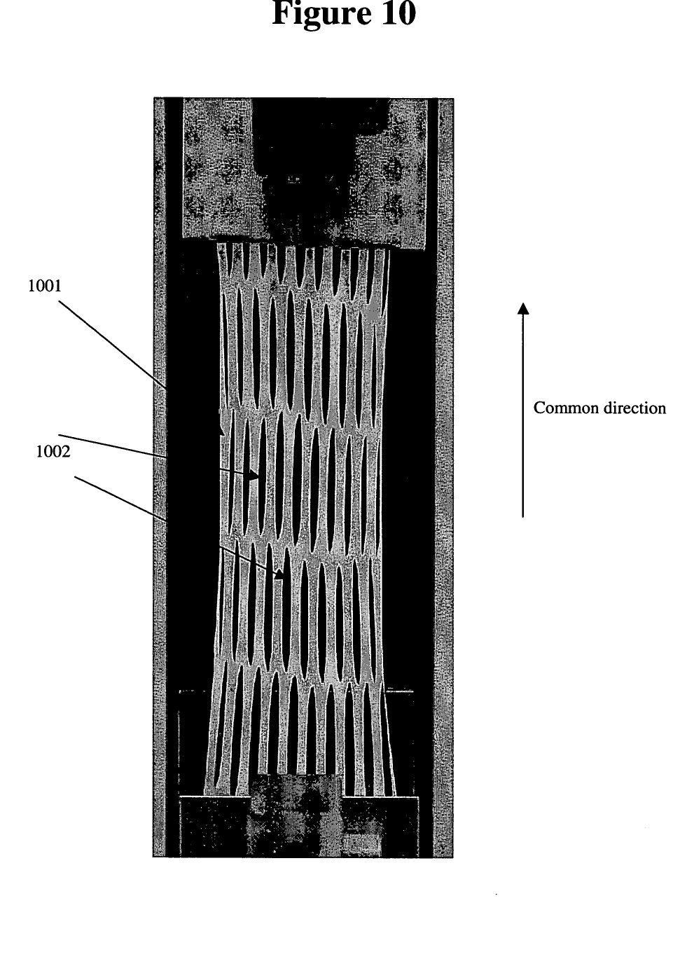

The expression “open area” of a region of slits is reported as a percentage (%) and is better understood by reference to FIG. 10, where the area of web that has opened in the plane of the web is seen as a black space in the photograph. The expression “open area” is accordingly the area of space seen as black (1002) in a photograph of the web divided by the total area of web in the slit region. The present inventor believes that it is difficult to correlate open area with film or web porosity, due in part to the dependence of the latter on pore size and shape, as well as the web thickness. For the intended uses that preferred embodiments of the present invention are intended, an open area of about 1% is sufficient to induce porosity that is above the levels of breathability in structures that are considered “breathable”. A minimum open area of about 0.5%, and preferably about 1% therefore is a useful practical lower limit on a preferred structure. In a preferred embodiment of the present invention, the said web has an open area of greater than 1% when stretched to 100% elongation.

The term “reversibly” in the context of embodiments of this invention denotes that upon application of a tensile force, the porosity of the web will increase, and upon removal of the tensile force, the porosity of the web will decrease. It is preferred that such increases and decreases in porosity will occur repeatedly in response to corresponding stretching and relaxing of the web through at least 20 cycles, and more preferably at least 50 cycles.

The term “nonwoven” in the context of embodiments of this invention preferably denotes a web comprising of a multitude of fibers. The fibers can be bonded to each other or can be unbonded. The fibers can be staple fibers or continuous fibers. The fibers can comprise a single material or can comprise a multitude of materials, either as a combination of different fibers or as a combination of similar fibers each comprised of different materials.

The nonwoven web useful in one embodiment of the present invention can be the product of any process for forming the same. Examples of known methods for manufacturing nonwoven webs include the processes that produce spun bond and melt blown nonwoven webs. The nonwoven web useful in various embodiments of the invention may be any of the known nonwoven webs, or it may be a composite or combination of webs, such as spunbond or melt blown webs. In a preferred embodiment of the invention, the web is a spunbond material, made of polypropylene fiber. Those skilled in the art will appreciate that the nonwoven web may be any polymeric material from which a fiber can be produced.

For a nonwoven web to be extensible in any given direction means that when a tensile force is applied to the web in that direction, the web expands in that direction, and a strain is induced in the web, preferable although not necessarily without breakage of fibers or undue distortion of the web structure.

The composite materials useful in various embodiments of the invention include a fibrous web (e.g., a nonwoven web) bonded to slitted material. Bonding can be accomplished be any of the several known mechanisms for bonding, that include, but are not limited to, adhesive lamination, thermal lamination and vacuum lamination.

The expression “adhesive lamination” refers to a process by which two web surfaces are bonded to each other by the application of adhesive, and optionally heat, to one or both of the webs, in a regular or random pattern. Sufficient pressure is applied to the surfaces in contact with each other that they remain affixed to each other when the pressure is removed.

The expression “thermal lamination” refers to a process by which two web surfaces are bonded to each other by the application of heat and pressure, such that the surfaces remain affixed to each other when the pressure is removed.

The expression “vacuum lamination” refers to a process by which two web surfaces are bonded to each other by the application of heat and vacuum, the vacuum being applied against one of the surfaces. One of the webs may be a molten curtain of polymer, from which the heat is removed by a screen or roll as the lamination with the other web proceeds.

The expression “absorbent article,” as used herein, refers to articles that absorb and contain liquid or semi-solid materials. More specifically, the expression refers to articles that are placed against or in proximity to the body of a wearer to absorb and contain the various exudates discharged from the body. The expression “absorbent article” is intended to include diapers, incontinent articles, sanitary napkins, pantiliners, and other articles used to absorb body exudates. The term “disposable” refers to articles that are intended to be discarded after a single use and preferably recycled, composted, or otherwise disposed of in an environmentally compatible manner i.e., they are not intended to be laundered or otherwise restored or reused as an absorbent article.

The term “diaper” refers to a garment generally worn by infants and incontinent persons that is drawn up between the legs and fastened about the waist of the wearer.

Examples of diapers are disclosed in U.S. Pat. Reissue No. 26,152, U.S. Pat. Nos. 3,860,003, 4,610,678, 4,673,402, 4,695,278, 4,704,115, 4,834,735, 4,888,231, 4,909,803. The disclosures of these patents are incorporated by reference herein in their entirety.

The expression “incontinence article” refers to pads, undergarments (pads held in place by a suspension system of same type, such as a belt, or the like), inserts for absorbent articles, capacity boosters for absorbent articles, briefs, bed pads, and the like, regardless of whether they are worn by adults or other incontinent persons. Examples of incontinence articles are disclosed in U.S. Pat. Nos. 4,253,461, 4,597,760, 4,704,115, 4,909,802, and 4,964,860. The disclosures of these patents are incorporated herein by reference in their entirety.

The expression “sanitary napkin” refers to an article that is worn by females adjacent to the pudendal region that is intended to absorb and contain various exudates that are discharged from the body (e.g., blood, menses, and urine). Examples of sanitary napkins are disclosed in U.S. Pat. Nos. 4,285,343, 4,589,876, 4,687,478, 4,917,697, 5,007,906, 4,950,264, and 5,009,653. The disclosures of these patents are incorporated by reference herein in their entirety.

In preferred embodiments of the present invention, the above referenced absorbent article, disposable diaper, elastic bandage, incontinence article, sanitary article each may comprise the web of this invention.

Sample Preparation and Tensile Measurements:

A sample of embossed elastic film was prepared by casting a molten web against a metal screen. The sample then was slit in three configurations using a hobby knife equipped with interchangeable blades. The unapertured film had a total gauge thickness of 3.13 mils. The slit regions encompassed the entire area of the film between the grips of a tensile tester (model Synergie 200 from MTS, of Eden Prairie, Minn.).

For the purposes of understanding the data in table 1, “load at 200% strain cycle 1” is the load sustained by a sample 50.8 mm wide with a gauge length of 31.75 mm after being stretched to 200% strain at 317.5 mm/minute.

“Load at 30% strain upon recovery cycle 2” is the load sustained by a sample 50.8 mm wide with a gauge length of 31.75 mm after being stretched to 200% strain at 317.5 mm/minute, at which extension it is held for 30 seconds, and then allowed to relax at 317.5 mm/minute to 0% extension at which it is held for 60 seconds and then stretched to 200% strain at 317.5 mm/minute at which extension it is held for 30 seconds, then allowed to relax at 317.5 mm/minute, and the load at 30% strain noted.

“Force relaxation during cycle 2 hold” is obtained after stretching a sample that is 50.8 mm wide with a gauge length of 31.75 mm to 200% strain at 317.5 mm/minute at which extension it is held for 30 seconds. It is then allowed to relax at 317.5 mm/minute to 0% extension at which it is held for 60 seconds and then stretched to 200% strain at 317.5 mm/minute at which extension it is held for 30 seconds. The measured force relaxation is the drop in load at the end of the 30 seconds hold relative to the load measured at the start of the hold period.

“Set cycle 2” is obtained after stretching a sample that is 50.8 mm wide with a gauge length of 31.75 mm to 200% elongation at 317.5 mm/minute, at which extension it is held for 30 seconds and then allowed to relax at 317.5 mm/minute to 0% extension at which it is held for 60 seconds, and then stretched at 317.5 mm/minute. The permanent set is the elongation of the sample at which the load cell detects a measurable load on the second extension.

Porosity Testing

Porosity testing was performed on a Textest FX 3300 (Advanced Testing Instruments Corp., S.C.) equipped with a 20 cm² orifice with a test pressure of 125 Pa.

Porosity was tested at sample extensions of 0%, 50%, 100% 150% and 200% for examples of slit elastic film, with slit patterns as noted in the table. The base film consisted of a tri-layer co-extruded film with a 2.4 mil thick core comprising a styrene block copolymer with skins 0.165 mil thick comprising low density polyethylene, linear low density polyethylene and isotactic polypropylene.

### EXAMPLES

One of the many advantages of certain embodiments of the present invention is the ability to retain most or even essentially all of the physical properties of an unapertured film. The following Table 1 shows the effect of slitting on the hysteresis properties of the film.

TABLE 1
Specimen width = 50.8 mm.
Specimen gauge length = 31.75 mm.
“N” = Newtons.

| | | | | Overlapping chisel |
|---|---|---|---|---|
| | | | Long slits | cut array |
| | Precursor | Staggered array | SL = 1.0 in | 0.236 in./0.85/−0.15/ |
| | film | 0.2 in./1/0/0.5 | SS = 0.2 in | 0.5 |
| Load at 200% strain | 6.57 | 6.50 | 6.53 | 6.45 |
| cycle 1 (N) | | | | |
| Load at 30% strain | 0.13 | 0.09 | 0.08 | 0.09 |
| upon recovery cycle 2 | | | | |
| (N) | | | | |
| Force relaxation | 16.4 | 16.8 | 16.4 | 16.6 |
| during cycle 2 hold | | | | |
| (%) | | | | |
| Set cycle 2 (%) | 15.0 | 15.8 | 15.9 | 15.8 |

The slit films all retained the load handling capability of the unslit film up to 200% elongation, with an increase in set on the second cycle of at most 0.9% on a base set for unslit film of 15.0%.

The tensile properties of various arrays described in table 2 are provided in Tables 3-5. The slit region encompasses the entire area of the film in these examples. The precursor film was identical to the precursor film used in the embodiment whose results are provided in table 1.

TABLE 2

| Slit Patterns | Slit Configurations |
|---|---|
| Short slits | 0.2″/1.0/0.5/0.5 |
| Long slits | Slits 1″ long with 0.2″ separation |
| Rectangular array | 0.2″/1.0/0.5/0.0 |
| Staggered array | 0.2″/1.0/0.0/0.5 |
| Overlapping array | 0.2″/1.0/−0.25/0.5 |

Tensile properties (peak load, strain at break and load at various strains from 5% to 500%) were determined by using line grips to stretch a specimen that was 50.8 mm wide and with a gauge length of either 25.4 mm or 31.75 mm at an elongation rate equivalent to 1000% of the initial gauge length per minute.

TABLE 3
Specimen width = 50.8 mm.
Specimen length = 25.4 mm.
“N” = Newtons

| | Precursor film | Short slits | Long slits |
|---|---|---|---|
| Peak load (N) | 49.5 | 46.0 | 39.4 |
| Strain at break (%) | 946 | 910 | 846 |
| Load at 5% strain (N) | 1.91 | 1.75 | 1.52 |
| Load at 10% strain (N) | 3.47 | 3.32 | 3.14 |
| Load at 15% strain (N) | 4.32 | 4.20 | 4.07 |
| Load at 50% strain (N) | 5.56 | 5.40 | 5.49 |
| Load at 100% strain | 5.85 | 5.82 | 5.73 |
| (N) | | | |
| Load at 200% strain | 6.43 | 6.44 | 6.32 |
| (N) | | | |
| Load at 300% strain | 7.54 | 7.53 | 7.41 |
| (N) | | | |
| Load at 400% strain | 9.47 | 9.49 | 9.31 |
| (N) | | | |
| Load at 500% strain | 12.65 | 12.68 | 12.45 |
| (N) | | | |

TABLE 4
Specimen width = 50.8 mm.
Specimen length = 31.75 mm.
“N” = Newtons.

| | | | | Over- |
|---|---|---|---|---|
| | | | | lap- |
| | Precursor | Rectangular | Staggered | ping |
| | film | array | array | array |
| Peak load (N) | 53.9 | 42.6 | 46.4 | 41.7 |
| Strain at break (%) | 870 | 765 | 801 | 767 |
| Load at 5% strain (N) | 2.35 | 2.18 | 2.19 | 2.10 |
| Load at 10% strain (N) | 3.81 | 3.62 | 3.64 | 3.53 |
| Load at 15% strain (N) | 4.52 | 4.36 | 4.37 | 4.28 |
| Load at 50% strain (N) | 5.60 | 5.49 | 5.48 | 5.40 |
| Load at 100% strain (N) | 5.90 | 5.81 | 5.81 | 5.73 |
| Load at 200% strain (N) | 6.60 | 6.53 | 6.54 | 6.45 |
| Load at 300% strain (N) | 7.98 | 7.95 | 7.95 | 7.83 |
| Load at 400% strain (N) | 10.52 | 10.56 | 10.54 | 10.37 |
| Load at 500% strain (N) | 15.19 | 15.35 | 15.30 | 15.01 |

TABLE 5
Specimen width = 25.4 mm.
Specimen length = 50.8 mm.
“N” = Newtons.

| | | Short | Long |
|---|---|---|---|
| | Precursor film | slits | slits |
| Peak load (N) | 27.2 | 22.6 | 25.1 |
| Strain at break (%) | 949 | 850 | 895 |
| Load at 5% strain (N) | 1.07 | 1.09 | 1.07 |
| Load at 10% strain (N) | 1.79 | 1.77 | 1.76 |
| Load at 15% strain (N) | 2.15 | 2.12 | 2.12 |
| Load at 50% strain (N) | 2.72 | 2.67 | 2.68 |
| Load at 100% strain | 2.86 | 2.83 | 2.84 |
| (N) | | | |
| Load at 200% strain | 3.17 | 3.13 | 3.14 |
| (N) | | | |
| Load at 300% strain | 3.73 | 3.71 | 3.73 |
| (N) | | | |
| Load at 400% strain | 4.74 | 4.71 | 4.74 |
| (N) | | | |
| Load at 500% strain | 6.49 | 6.49 | 6.53 |
| (N) | | | |

It will be seen from the tables 3 to 5 that there is very little, if any, loss in load bearing ability in slit films when compared to the precursor film.

Table 6 provides porosity data from three representative slit patterns, according to the testing protocol defined under the section “Test Methods”.

For comparative purposes, a vacuum apertured elastic film also was tested under identical conditions and the results are provided in table 7. The vacuum apertured elastic film was a tri-layer co-extruded film with a 2.8 mil thick core comprising a styrene block copolymer with skins 0.165 mil thick comprising low density polyethylene and linear low density polyethylene.

TABLE 6

| | Porosity (m³/m²/min) | | | | |
|---|---|---|---|---|---|
| | Extension = | Extension = | Extension = | Extension = | Extension = |
| Slit Pattern | 0% | 50% | 100% | 150% | 200% |
| 2.5 mm/1.0/0.0/0.5 | 0.6 | 13.0 | 33.4 | 39.1 | 42.1 |
| 2.5 mm/0.67/0.0/0.5 | 0.4 | 9.0 | 19.7 | 24.3 | 31.3 |
| 2.5 mm/2.0/0.0/0.5 | 0.3 | 4.2 | 14.7 | 17.8 | 18.6 |

TABLE 7

| | Porosity (m³/m²/min) | | | | |
|---|---|---|---|---|---|
| | Extension = | Extension = | Extension = | Extension = | Extension = |
| | 0% | 50% | 100% | 150% | 200% |
| Vacuum | 24.6 | 6.1 | 0.8 | 0.4 | 0.2 |
| apertured film | | | | | |

From tables 6 and 7 it can be seen that whereas the porosity of the slit arrays increases when the film is placed under tension, the vacuum apertured film porosity actually decreases, to the point that it could be considered to be no longer breathable. The slit pattern 2.5 mm/1.0/0.0/0.5 represents a preferred embodiment of the present invention in that it maximizes the porosity available for the structure.

The utility of the present invention can be expanded to form a composite material by lamination of the elastic web to other webs, and in particular nonwoven materials that can impart softness and loft. Lamination of webs can be achieved by several methods. Suitable methods include, but are not limited to, vacuum lamination, adhesive lamination, and thermal lamination. Webs that are bonded to the slitted web of this invention may be referred to as “secondary webs,” however, it is to be understood that this expression in fact includes the case where only one secondary web is bonded to the elastic web of the invention.

In a preferred embodiment, a composite material comprises the web, wherein the web is bonded to one or both surfaces by a bonding mechanism to one or more secondary webs. In a preferred embodiment, the composite material comprises the web bonded to a secondary web, wherein the secondary web comprises a nonwoven fabric. Preferably, the secondary webs are nonwoven fabrics that are extensible in a common direction of the stretchable web. In another preferred embodiment, the composite materials are bonded by bonding means comprising vacuum lamination and adhesive lamination.

While the examples of the embodiments of the present invention presented above have been limited to certain sizes and configurations of slits and regions of slits, it is recognized that similar advantages can be obtained by other sizes and configurations of slits and regions of slits. Those skilled in the art will recognize that various changes and modifications can be made to the various embodiments of the invention without departing from the spirit and scope of this invention. All such modifications are within the scope of this invention.

We claim:

1. A stretchable web comprising a top surface and a bottom surface, the web comprising one or more regions having a plurality of slits, wherein:
i. each slit connects the top surface to the bottom surface;
ii. the slits are aligned with their major axes oriented at an angle within 45° of a common direction on the web surface;
iii. the slits open when a tensile force is applied to the web along the common direction;
iv. the slits are characterized by a major and a minor axes, the ratio of the major to minor axes (the aspect ratio) being more than about 5; and
v. the stretchable web has a porosity of greater than about 1.0 (m³/m²/min) when stretched to 50% elongation.

2. The web of claim 1 wherein the slits are aligned each with their major axes oriented at an angle within 30° of a common direction on the web surface.

3. The web of claim 1 wherein the slits are aligned each with their major axes oriented at an angle within 15° of a common direction on the web surface.

4. The web of claim 1 wherein the slits are aligned each with their major axes essentially parallel to a common direction on the web surface.

5. The web of claim 1 wherein the ratio of the major axis to the minor axis of at least one of the plurality of slits is greater than about 25.

6. The web of claim 1 wherein the slits are positioned randomly within any one or more of said regions in the web.

7. The web of claim 1 wherein the arrangement of slits within any one or more of said regions is organized in an array, the array comprising rows of slits that are essentially parallel in their major axes.

8. The web of claim 7 wherein the array has a hexagonal symmetry such that the row offset value RO=SS/2, where SS is the relative slit separation.

9. The web of claim 7 wherein the array has a rectangular symmetry such that the row offset value RO=0 (zero).

10. The web of claim 7 wherein the array has a staggered configuration such that the row offset value RO is not equal to SS/2, where SS is the relative slit separation.

11. The web of claim 7 wherein the value of the relative row separation of the array RS, is between about −0.9 and about 10.0.

12. The web of claim 7 wherein the relative row offset value of RO is less than about 0.5.

13. The web of claim 1 wherein the number density of slits per square inch within any one or more of the regions is between about 5 and about 1,000.

14. The web of claim 1 wherein the total length of slits per square inch within any one or more of the regions is between about 0.5 and about 50 inches/square inch.

15. An absorbent article comprising the web of claim 1.

16. A disposable diaper comprising the web of claim 1.

17. An elastic bandage comprising the web of claim 1.

18. An incontinence article comprising the web of claim 1.

19. A sanitary article comprising the web of claim 1.

20. A composite material comprising the web of claim 1 bonded to a secondary web.

21. The composite material of claim 20 wherein the secondary web comprises a nonwoven fabric.

22. The composite material of claim 20 wherein the webs are bonded either by vacuum lamination or by adhesive lamination.

23. The composite material of claim 20 wherein the secondary webs are nonwoven fabrics that are extensible in a common direction of the stretchable web.

24. An elastic web with a top surface and a bottom surface, said web comprising one or more regions having a multiplicity of slits, wherein:
i. each slit connects the top surface to the bottom surface;
ii. the slits are aligned with their major axes oriented at an angle within 45° of a common direction on the web surface;
iii. the slits open when a tensile force is applied to the web along the common direction;
iv. the slits are characterized by a major and a minor axes, the ratio of the major to minor axes (the aspect ratio) being more than about 5; and
v. the region has an open area of greater than 1% when stretched to 100% elongation.

25. The web of claim 24 wherein the slits are aligned each with their major axes oriented at an angle within 30° of a common direction on the web surface.

26. The web of claim 24 wherein the slits are aligned each with their major axes oriented at an angle within 15° of a common direction on the web surface.

27. The web of claim 24 wherein the slits are aligned each with their major axes essentially parallel to a common direction on the web surface.

28. The web of claim 24 wherein the ratio of the major axis to the minor axis (aspect ratio) of at least one of the plurality of slits is greater than about 25.

29. The web of claim 24 wherein the slits are positioned randomly within any one or more of said regions in the web.

30. The web of claim 24 wherein the arrangement of slits within any one or more of the regions is organized in an array, the array comprising rows of slits that are essentially parallel in their major axes.

31. The web of claim 30 wherein the array has a hexagonal symmetry such that the row offset value RO=SS/2, where SS is the relative slit separation.

32. The web of claim 30 wherein the array has a rectangular symmetry such that the row offset value RO=0 (zero).

33. The web of claim 30 wherein the array has a staggered configuration such that the row offset value RO is not equal to SS/2, where SS is the relative slit separation.

34. The web of claim 30 wherein the value of the relative row separation of the array RS, is between about −0.9 and about 10.0.

35. The web of claim 30 wherein the relative row offset value of RO is less than 0.5.

36. The web of claim 24 wherein the number density of slits per square inch within any one or more of the regions is between about 5 and about 1,000.

37. The web of claim 24 wherein the total length of slits per square inch within any one or more of the regions is between about 0.5 and about 50 inches/square inch.

38. An absorbent article comprising the web of claim 24.

39. A disposable diaper comprising the web of claim 24.

40. An elastic bandage comprising the web of claim 24.

41. An incontinence article comprising the web of claim 24.

42. A sanitary article comprising the web of claim 24.

43. A composite material comprising the web of claim 24 bonded to a secondary web.

44. The composite material of claim 43 wherein the secondary web comprises a nonwoven fabric.

45. The composite material of claim 43 wherein the webs are bonded either by vacuum lamination or by adhesive lamination.

46. The composite material of claim 43 wherein the secondary webs are nonwoven fabrics that are extensible in a common direction of the stretchable web.

47. The web as claimed in claim 1, wherein the slit length is within the range of from about 0.25 to about 25 mm.

48. The web as claimed in claim 47, wherein the slit length is within the range of from about 2.5 to about 6.25 mm.

49. The web of claim 24, wherein the slit length is within the range of from about 0.25 to about 25 mm.

50. The web as claimed in claim 49, wherein the slit length is within the range of from about 2.5 to about 6.25 mm.
